(19) United States
(12) Patent Application Publication
(10) Pub. No.: US 2018/0004965 A1
(43) Pub. Date: Jan. 4, 2018

(54) ADDING GROUP EMAIL ALIAS TO EMAIL LIST

(71) Applicant: International Business Machines Corporation, Armonk, NY (US)

(72) Inventors: Yogesh S. Gawali, Sydney (AU); Shashank D. Kharche, Sydney (AU); Chee Hoe Quek, Sydney (AU); Wei Chen Sun, Sydney (AU)

(21) Appl. No.: 15/196,719

(22) Filed: Jun. 29, 2016

(51) Int. Cl. G06F 21/62; G06F 17/30

(52) U.S. Cl. CPC G06F 21/62; G06F 17/30386

(57) ABSTRACT

With dynamically and drastically changing work culture, it is difficult to keep track of group email IDs of various teams in an organization. The present invention provides a method of adding group email aliases to a list of email recipients by typing one member's email ID of the group email aliases. The association information between a team member's email ID and a corresponding group email alias is stored in a central database and is identified during adding the team member's email ID to an email recipient list.

### BACKGROUND

The present invention relates generally to the field of electronic messaging, and more particularly to electronic mails (emails).

Generally speaking, electronic messaging refers to the creation, storage, exchange, and management of text, images, voice, video, e-mail, and/or fax over a communications network. The electronic messaging may be categorized as instant messaging, text messaging, email, and voicemail.

Electronic mail (email), as one type of electronic messaging, is widely used and plays a very important role for individual users and businesses. Email is a method of exchanging digital messages between computer users over a communication network (e.g., Internet). Email generally includes a message header and a message body. The message header includes fields such as From (i.e., the email address of sender), To (i.e., the email address(es) of the message's recipient(s)), CC (carbon copy), Subject (i.e., a brief summary of the topic of the message), Date, and other information about the email.

### SUMMARY

In one aspect of the present invention, a method, a computer program product, and a system, includes: associating an email identification (ID) of an individual user with a set of group email aliases; defining a set of roles for the individual user, each role of the set of roles respectively corresponding to an alias of the set of group email aliases; adding the email ID to an email recipient list; displaying the set of roles by activating the email ID; selecting a preferred role from the set of roles; displaying the set of group email aliases by activating the preferred role; selecting a preferred group email alias from the set of group email aliases; and adding the preferred group email alias to the email recipient list.

### BRIEF DESCRIPTION OF THE SEVERAL VIEWS OF THE DRAWINGS

FIG. 1 is a schematic view of a first embodiment of a system according to the present invention;

FIG. 2 is a flowchart depicting an embodiment of a method that may be performed, at least in part, by the system depicted in FIG. 1;

FIG. 3 is a schematic view of a machine logic (for example, software) portion of the system depicted in FIG. 1;

FIG. 4 is a schematic diagram depicting a relationship among groups and members according to one embodiment of the present invention;

FIG. 5 is an example of a set of roles an individual user may have for a group according to one embodiment of the present invention;

FIG. 6 is an example of a set of group email aliases with which an individual user may be associated as a member of the set of groups according to one embodiment of the present invention; and

FIG. 7 is an example of a set of group email aliases with which an individual user may be associated as an administrator of the set of groups according to one embodiment of the present invention.

### DETAILED DESCRIPTION

A method is provided for adding group email aliases to an email list quickly and easily. Group email alias names, details about administrator (owner/moderator) of the group emails, and email addresses of all members of the group emails are stored in a central database. A user/member may be part of more than one group email aliases. The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium, or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network, and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture, including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions, or acts, or carry out combinations of special purpose hardware and computer instructions.

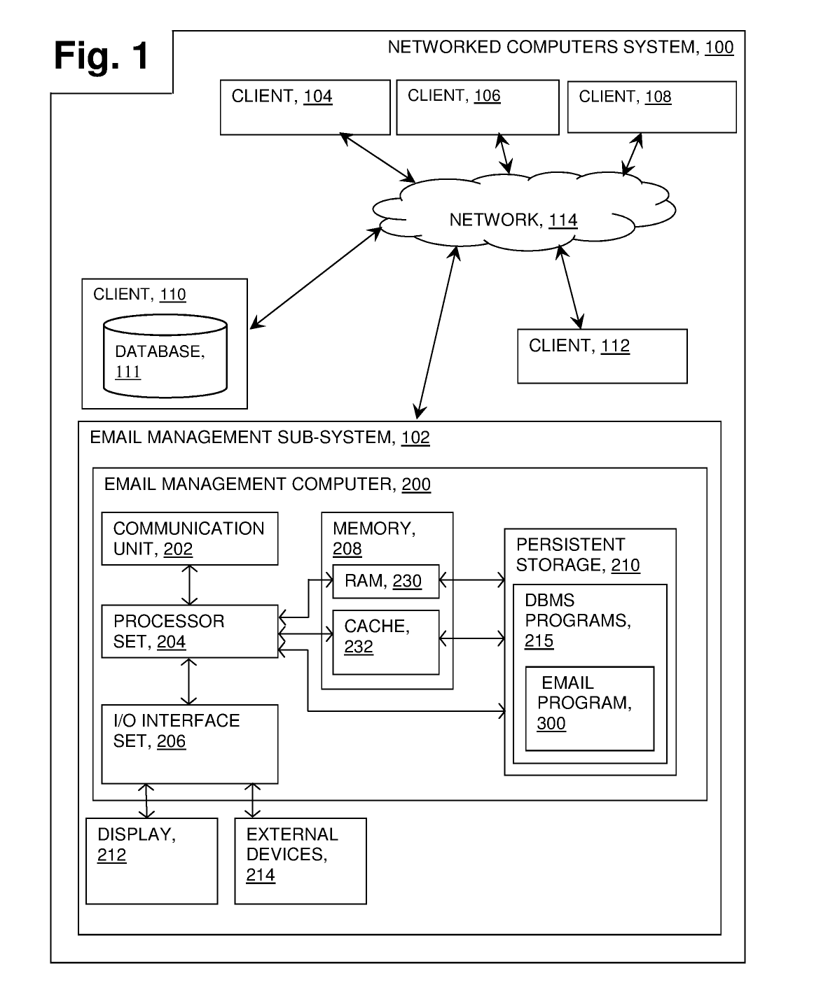

The present invention will now be described in detail with reference to the Figures. FIG. 1 is a functional block diagram illustrating various portions of networked computers system 100, in accordance with one embodiment of the present invention, including: email management (DBM) sub-system 102; client sub-systems 104, 106, 108, 110, 112; database 111; communication network 114; email management computer 200; communication unit 202; processor set 204; input/output (I/O) interface set 206; memory device 208; persistent storage device 210; display device 212; external device set 214; database management system (DBMS) programs 215; random access memory (RAM) devices 230; cache memory device 232; and email program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage, and control certain software functions that will be discussed in detail below.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware component within a system. For example, the communications fabric can be implemented, at least in part, with one or more buses.

Memory 208 and persistent storage 210 are computer readable storage media. In general, memory 208 can include any suitable volatile or non-volatile computer readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Program 300 is located within DBMS programs 215, where other programs (not shown) carry out various functions of database management. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions, and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either, or both, physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with computer 200. For example, I/O interface set 206 provides a connection to external device set 214. External device set 214 will typically include devices such as a keyboard, keypad, a touch screen, and/or some other suitable input device. External device set 214 can also include portable computer readable storage media such as, for example, thumb drives, portable optical or magnetic disks, and memory cards. Software and data used to practice embodiments of the present invention, for example, program 300, can be stored on such portable computer readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the present invention. However, it should be appreciated that any particular program nomenclature herein is used merely for convenience, and thus the present invention should not be limited to use solely in any specific application identified and/or implied by such nomenclature.

Database 111 is an organized collection of data. The data is typically organized to model aspects of reality in a way that supports processes requiring information. For example, modelling the availability of rooms in hotels in a way that supports finding a hotel with vacancies.

Program 300 operates to manage an email system that is stored in a central database. The email system contains data of all group email aliases. Program 300 further identifies one or more corresponding group email aliases when a user inputs an individual email ID/address to an email list of recipient. The one or more corresponding group email aliases are associated with the individual email ID.

Some embodiments of the present invention recognize the following facts, potential problems and/or potential areas for improvement with respect to the current state of the art: (i) employees in an organization change their job roles frequently; (ii) keep tracking of group email IDs of various teams in an organization becomes difficult due to dynamically changing work environment in the organization; and/or (iii) the group email aliases of different teams need to be known in order to use the group email aliases.

When an organization grows exponentially, the number of employees increases rapidly too and employees switch their job roles quite frequently within the organization. In such dynamically and drastically changing work culture, it is significantly not convenient to keep track of email IDs (identifications), specifically group email IDs of various teams. Usually a group email alias is used to send an email to a particular team (i.e., a group of people/employees). A group email alias generally refers to an alternate email address that points to email addresses of people belonging to the group. For example, a group email alias saying “AAA BBB Senior Managers APAC” may points to all BBB senior managers in the APAC region.

Each group alias has one or more administrators who have an authority to add or remove a member from a group. The administrator is also referred as a group owner or a group moderator.

The difficulty with making use of a group email alias is that the group email alias of different teams need to be known, because most of the time only one or more members from that team are identified, but not the group email alias of their team. For example, a team member A from an application team wants to contact a team member B from a database team for some database queries. But the member B is not available on a chat messenger or may be out of the office. Then the member A wants to contact B′s team for the database queries via email. However the member A does not know the group email alias for the database team. Further, for example, a person C is appointed as a senior manager, and persons D, E and F are his/her direct reporters. The person C may want to contact each team that D, E and F manages individually. The person C knows email IDs of B, C, and D but may not know their team's group email aliases.

In some embodiments of the present invention, a method of identifying group email aliases with significant ease is provided. In such embodiments, group email alias names, details about administrator (owner/moderator) and email addresses of all members are stored in a central database, for example, database 111 in FIG. 1. Such stored information is utilized to locate the group email alias and to identify the relationship between a user/employee/team member and the corresponding group email alias that the user belongs to.

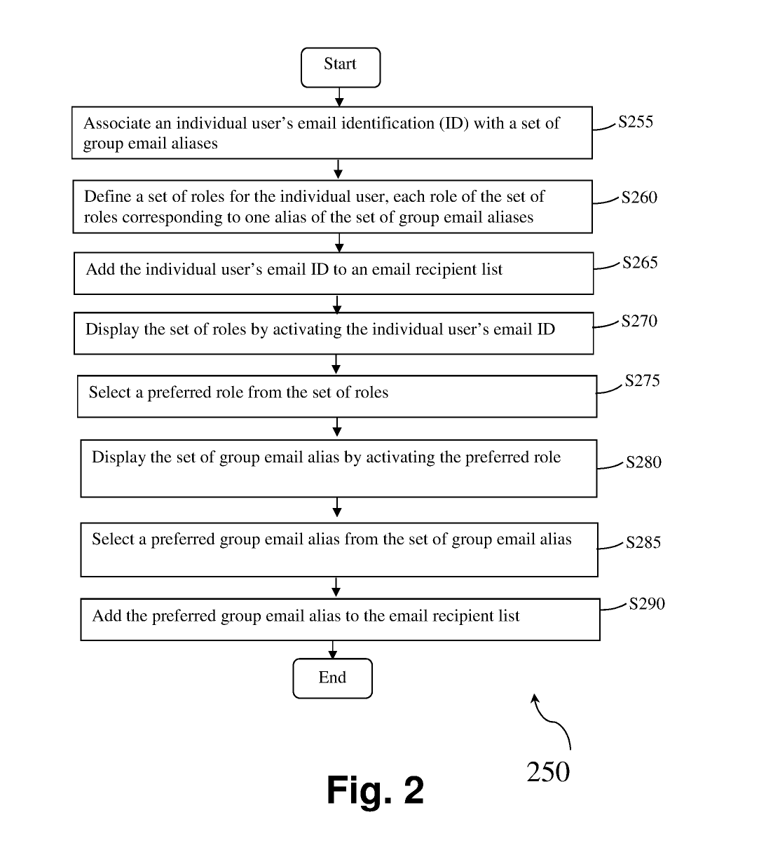

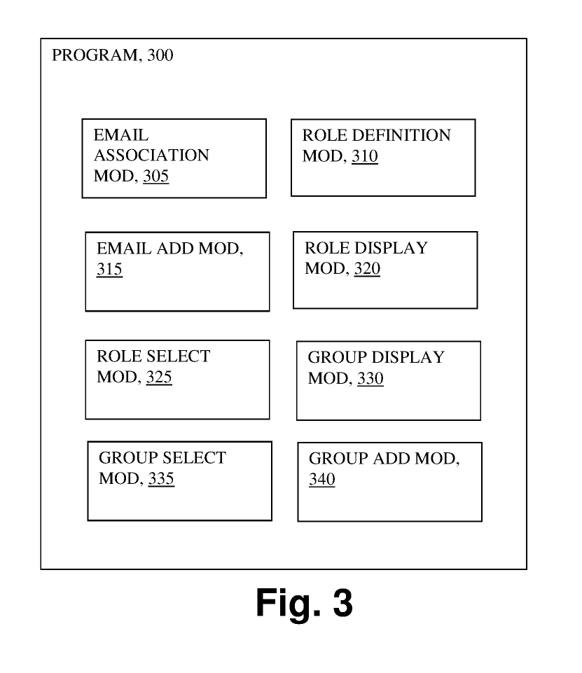

FIG. 2 shows flowchart 250 depicting a first method according to the present invention. FIG. 3 shows program 300 for performing at least some of the method steps of flowchart 250. This method and associated software will now be discussed, over the course of the following paragraphs, with extensive reference to FIG. 2 (for the method step blocks) and FIG. 3 (for the software blocks).

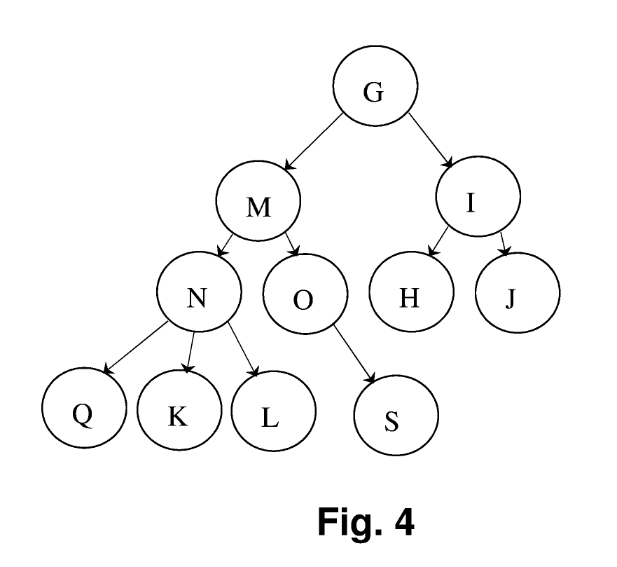

Processing begins at step S255, where email association module (“mod”) 305 associates an individual user's email ID with a set of email aliases. In this example, the individual user may be an employee or a member of a group/team in an organization. The user's email ID is also referred to as the user's email address. The association relationship between the individual user and the set of groups is defined and stored in a database, such as the database 111 in FIG. 1. An example of such association relationship is shown in FIG. 4 which depicts a reporting structure in an organization. For example, G holds a highest position and N manages Q, K, and L. A member may be associated with one or more groups. Group email alias names and email addresses of all members are stored in the database 111.

Processing proceeds to step S260, where role definition module 310 define a set of roles for the individual user. Each role of the set of roles corresponds to one alias of the set of group email aliases. In this example, the set of roles may include one or more of administrator, owner, moderator, and/or member. Each user may be part of more than one group email aliases. So each user defines their own primary group email alias in the central database. The primary group email alias is the one which the user primarily works for. If a user manages multiple teams, there may not be a single primary group. In this case, the user can leave the primary group as blank. Details about administrator, owner or moderator of a group email alias is stored in the central database 111.

Processing proceeds to step S265, where email add module 315 adds the individual user's email ID to an email recipient list. In this example in FIG. 4, H knows that N manages a database team and H needs to find out the group email alias for the database team managed by N. H enters/adds N's email ID on a recipient list of an email application.

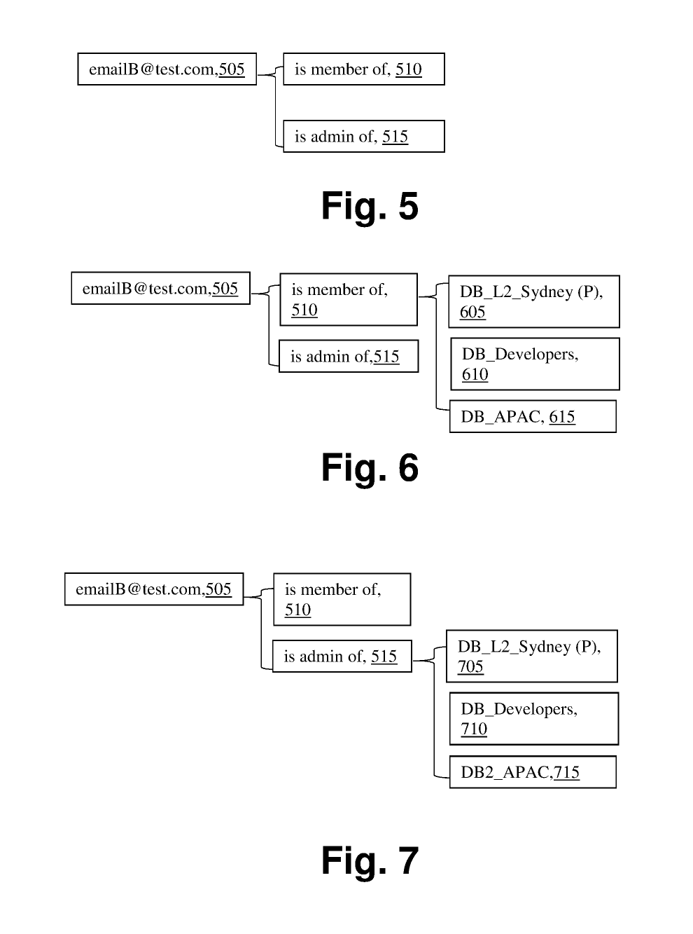

Processing proceeds to step S270, where role display module 320 displays the set of roles by activating the individual user's email ID. In this example, by right clicking on N's email ID (505 in FIG. 5), a set of roles associated with N is shown, for example, N is “is member of” (510 in FIG. 5) and “is admin of” (515 in FIG. 5).

Processing proceeds to step S275, where role select module 325 selects a preferred role from the set of roles displayed in step S270. In this example, by clicking on “is member of” (510 in FIG. 6), the role of N as a member of a group is selected. Alternatively, by clicking on “is admin of” (515 in FIG. 6), the role of N as an administrator of a group is selected.

Processing proceeds to step S280, where group display module 330 displays the set of group email aliases by activating the preferred role. In this example, by clicking on “is member of” (510 in FIG. 6), the central database 111 is further searched to show a list of all groups/group email aliases of which the N is a member, such as the N is a member of, or belongs to a database team in Sydney (605 in FIG. 6), a database developer team (610 in FIG. 6), and/or APAC group (615 in FIG. 6). Alternatively, by clicking on “is admin of” (515 in FIG. 7), the central database 111 is further searched to show a set of all groups/group email aliases the N owns/administers, such as a database team in Sydney (705 in FIG. 7), a database developer team (710 in FIG. 7), and/or APAC group (715 in FIG. 7).

Processing proceeds to step S285, where group select module 335 selects a preferred group email alias from the set of group email aliases. In this example, for example, by clicking on “DB_L2_Sydney” (605 in FIG. 6), the group email alias associated with this group is selected. Similarly, other group email aliases may be selected of which the N is a member. Alternatively, by clicking on 705 “DB_L2_Sydney” in FIG. 7, the group email alias associated with this group is selected. Similarly, other group email aliases may be selected which the N administers.

Processing proceeds to stop at step S290, where group add module 340 adds the preferred email alias to the email recipient list. In this example, for example, the group email alias associated with a group of which the N is a member is added to the email recipient list by clicking on the group email alias. Further, more group email aliases may be added to a same recipient list. Further, the additional (P) at the end of group name of 605 in FIG. 6 and of 705 in FIG. 7 indicates that the user N is a primary member of that group.

Some embodiments of the present invention may include one, or more, of the following features, characteristics and/or advantages: (i) detailed information regarding group email aliases is stored in a central database and is used to associate an individual's/user's email with a corresponding group email alias; (ii) group email aliases can be identified quickly and easily; and/or (iii) a user/member may belong to or own one or more group emails.

Some helpful definitions follow:

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A method comprising:
associating an email identification (ID) of an individual user with a set of group email aliases;
defining a set of roles for the individual user, each role of the set of roles respectively corresponding to an alias of the set of group email aliases;
adding the email ID to an email recipient list;
displaying the set of roles by activating the email ID;
selecting a preferred role from the set of roles;
displaying the set of group email aliases by activating the preferred role;
selecting a preferred group email alias from the set of group email aliases; and
adding the preferred group email alias to the email recipient list.

2. The method of claim 1, wherein the set of roles includes one or more of the following:
(i) a member; (ii) an administrator; (iii) an owner; and (iv) a moderator.

3. The method of claim 1, wherein the displaying the set of roles by activating the email ID includes clicking on the email ID.

4. The method of claim 1, further comprising:
searching a database to locate the set of roles.

5. The method of claim 1, wherein the displaying the set of group email aliases by activating the preferred role includes clicking on the preferred role.

6. The method of claim 1, further comprising:
searching a database to locate the set of group email aliases.

7. The method of claim 1, further comprising:
defining a primary group email alias for the email ID.

8. A computer program product comprising a computer readable storage medium having stored a set of instructions stored therein which, when executed by a processor, causes the processor to identify group email aliases by:
associating an email identification (ID) of an individual user with a set of group email aliases;
defining a set of roles for the individual user, each role of the set of roles respectively corresponding to an alias of the set of group email aliases;
adding the email ID to an email recipient list;
displaying the set of roles by activating the email ID;
selecting a preferred role from the set of roles;
displaying the set of group email aliases by activating the preferred role;
selecting a preferred group email alias from the set of group email aliases; and
adding the preferred group email alias to the email recipient list.

9. The computer program product of claim 8, wherein the set of roles includes one or more of the following: (i) a member; (ii) an administrator; (iii) an owner; and (iv) a moderator.

10. The computer program product of claim 8, wherein the displaying the set of roles by activating the email ID includes clicking on the email ID.

11. The computer program product of claim 8, further comprising:
searching a database to locate the set of roles.

12. The computer program product of claim 8, wherein the displaying the set of group email aliases by activating the preferred role includes clicking on the preferred role.

13. The computer program product of claim 8, further comprising:
searching a database to locate the set of group email aliases.

14. The computer program product of claim 8, further comprising:
defining a primary group email alias for the email ID.

15. A computer system comprising:
a processor set; and
a computer readable storage medium;
wherein:
the processor set is structured, located, connected, and/or programmed to run program instructions stored on the computer readable storage medium; and
the program instructions which, when executed by the processor set, cause the processor set to identify group email aliases by:
associating an email identification (ID) of an individual user with a set of group email aliases;
defining a set of roles for the individual user, each role of the set of roles respectively corresponding to an alias of the set of group email aliases;
adding the email ID to an email recipient list;
displaying the set of roles by activating the email ID;
selecting a preferred role from the set of roles;
displaying the set of group email aliases by activating the preferred role;
selecting a preferred group email alias from the set of group email aliases; and
adding the preferred group email alias to the email recipient list.

16. The computer system of claim 15, wherein the set of roles includes one or more of the following: (i) a member; (ii) an administrator; (iii) an owner; and (iv) a moderator.

17. The computer system of claim 15, wherein the displaying the set of roles by activating the email ID includes clicking on the email ID.

18. The computer system of claim 15, further comprising:
searching a database to locate the set of roles.

19. The computer system of claim 15, wherein the displaying the set of group email aliases by activating the preferred role includes clicking on the preferred role.

20. The computer system of claim 15, further comprising:
searching a database to locate the set of group email aliases.
